(19) United States
(12) Patent Application Publication
(10) Pub. No.: US 2026/0135150 A1
(43) Pub. Date: May 14, 2026

(54) PRODUCTION OF A LIQUID ORGANIC ELECTROLYTE METAL-ION BATTERY COMPONENT, AND ELECTROCHEMICAL CELL COMPRISING SUCH A COMPONENT

(71) Applicants: CENTRE NATIONAL DE LA RECHERCHE SCIENTIFIQUE, Paris (FR); UNIVERSITE AMIENS PICARDIE JULES VERNE, Amiens (FR); UNIVERSITE DE LILLE, Lille (FR); ECOLE NATIONALE SUPERIEURE DES ARTS ET INDUSTRIES TEXTILES, Roubaix (FR)

(72) Inventors: Alexis MAUREL, Gragnague (FR); Sylvie GRUGEON, Feuquieres (FR); Loïc DUPONT, Pierregot (FR); Stéphane PANIER, Arras (FR); Aurélie CAYLA, Villeneuve D'Ascq (FR); Luisa Larissa Arnaldo GOMES, Cambridge, MA (US); Victor BOUDEVILLE, Amiens (FR)

(21) Appl. No.: 19/120,028

(22) PCT Filed: Oct. 13, 2023
(86) PCT No.: PCT/FR2023/051600

§ 371 Date: Apr. 10, 2025

(30) Foreign Application Priority Data
Oct. 14, 2022 (FR) FR2210610

(51) Int. Cl. H01M 10/0569; H01M 10/0525; H01M 10/054

(52) U.S. Cl. CPC H01M 10/0569; H01M 10/0525; H01M 10/054; H01M 2300/0028; H01M 2300/0091

(57) ABSTRACT

A method for producing metal-ion battery components, the components that can be obtained by this method and the use of these components in the production of a liquid organic electrolyte electrochemical cell.

### TECHNICAL FIELD OF THE INVENTION

The present invention belongs to the technical field of metal-ion battery components (positive electrode, negative electrode or separator), obtained by extrusion directly in the form of films, or formed from composite filaments or composite granules by a fused deposition method. The present invention relates more particularly to a method for manufacturing such components, the components likely to be obtained by this method and the use of these components in the manufacture of an electrochemical cell with liquid organic electrolyte.

### TECHNICAL BACKGROUND

The metal-ion (lithium or sodium) battery with liquid organic electrolyte is the technology of choice for many applications (mobile devices, automotive, stationary, aerospace, etc.) and its large-scale sale encourages researchers to continuously increase their performance and develop sustainable and environmentally friendly manufacturing processes.

Additive manufacturing (usually referred to by the acronym FA), and in particular the fused material deposition method (internationally referred to by the acronyms FFF for “Fused Filaments Fabrication” or FGF for “Fused Granular Fabrication”) is attractive because it allows a design flexibility and a solvent-free manufacturing. Using this technology, also known as a 3D printing process, it is possible, on the one hand, to produce three-dimensional battery architectures with higher active surfaces that theoretically increase the specific capacity at high cycling rates. On the other hand, this technology allows the battery to be perfectly adapted to the shape of the final object, thus maximizing energy storage capacities.

3D printing of a battery requires the production of filaments or composite granules corresponding to the different components: separator, positive and negative electrodes. These composite filaments or granules typically comprise a thermoplastic polymer matrix in which different materials such as electrochemically active materials, electrically conductive components, ceramic nanoparticles, plasticizers, etc. are added according to their targeted role.

After the 3D printing or assembly phase, the battery electrodes and the separator must be able to be impregnated with a liquid electrolyte while maintaining their mechanical integrity. However, so far, in the case of a component including a single polar thermoplastic polymer WO 2016/036607:
either the liquid electrolyte could not penetrate the heart of an electrode printed by FFF: in this case, only the active material on the surface of the electrodes was accessible to the electrolyte making the electrochemical reaction partial and difficult, which resulted, on the electrochemical curves, in a significant polarization and a very low capacity;
or the polymer could become impregnated with electrolyte, but the mechanical integrity was lost after a few cycles and the performance of the battery was affected accordingly.

Furthermore, the electrode of WO 2016/036607 contains no more than 50% by weight of electrochemically active material, and typically between 10% and 30% by weight relative to the weight of the polymer. Moreover, international application WO 2019/2019202600 also teaches the production by additive manufacturing of an electrode having a single functional polymer, in which the electronically conductive carbon (at a rate of 50 to 70% by weight) and the electrochemically active material are dispersed.

The methods taught by International Applications WO 2016/036607 and WO 2019/202600 have the drawbacks of providing electrodes with a limited mass content of electrochemically active material (less than 50%) or electrodes with poor mechanical strength or with limited electrolyte wetting properties.

### DISCLOSURE OF THE INVENTION

More particularly, in order to overcome the aforementioned drawbacks, the applicant has developed a method for manufacturing composite filaments, composite films or composite granules to make liquid organic electrolyte metal-ion battery components, said method comprising the steps of:
a. providing or preparing at least two thermoplastic polymer compositions, including a first non-polar polymer composition comprising at least one first non-polar thermoplastic polymer, said first non-polar thermoplastic polymer having a melting temperature Tf1 and having no affinity with the liquid organic electrolyte of said metal-ion battery to which it is intended to be integrated, and
   a second polar polymer composition comprising at least one polar thermoplastic polymer, said polar thermoplastic polymer having a melting temperature Tf2 and having an affinity with said liquid organic electrolyte, said non-polar thermoplastic polymer and said first polar thermoplastic polymer being immiscible,
b. mixing said at least first and second non-polar and polar polymer compositions, to form a thermoplastic polymer mixture;
c. introducing said composite composition into an extruder, then forming by extrusion composite granules, or composite filaments, or composite films;
   said extrusion step being carried out at a temperature Te which is equal to or greater than the melting temperature of said thermoplastic polymer mixture, and preferably 10° C. higher than the melting temperature of said thermoplastic polymer mixture; said composite granules or said composite films or said composite filaments thus obtained at the end of the extrusion step consisting of a polymer matrix having a co-continuous morphology of said polar thermoplastic polymer and said first non-polar thermoplastic polymer, to ensure the electrochemical function and mechanical strength.

the term “polymers derived from a given monomer” means, within the meaning of the present invention, both the homopolymers derived from this single monomer and the copolymers derived from this given monomer and at least one other different monomer.

the term “co-continuous morphology” means, within the meaning of the present invention, a polymer matrix comprising a mixture of immiscible polymers each forming a continuous network within the matrix.

With respect to step c), if the thermoplastic polymer mixture obtained in step b) includes only the first and second thermoplastic polymer compositions (without plasticizer-type additives), the melting temperature of the thermoplastic polymer mixture will correspond to the highest of the temperatures Tf1 and Tf2. In the presence of plasticizer, the melting temperature of the thermoplastic polymer mixture may be lower than Tf2.

As plasticizers that can be used within the scope of the present invention, mention may be made in particular of plasticizers of the ATBC (Acetyl TriButyl Citrate), PC (propylene carbonate) . . . type.

The first non-polar polymer composition comprises a first non-polar thermoplastic polymer, which allows ensuring the mechanical stability of the component during the battery operation. The first nonpolar thermoplastic polymer is inert with respect to the electrolyte.

The first polymer composition may if necessary (if the component is an electrode) comprise the active material and the carbon fillers, thus acting as host structure and ensuring the mechanical strength of the electrode.

As first nonpolar thermoplastic polymers that can be used within the scope of the present invention, mention may be made in particular of olefins and mixtures thereof, and is preferably a polypropylene (PP) or a polyethylene (PE).

The first non-polar polymer composition may also comprise a second non-polar thermoplastic polymer selected from saturated (e.g., olefin-type copolymers) or unsaturated (e.g., polystyrene or SBR) elastomeric non-polar polymers and/or mixtures thereof. A polypropylene-based elastomer (PBE) will preferably be used as the second non-polar polymer. This second non-polar polymer allows providing a greater flexibility to the final component obtained (which may be in the form of a filament, and preferably in the form of a coilable filament), while also being inert with respect to the electrolyte.

The second polar polymer composition comprises a polar thermoplastic polymer, which has an affinity with the electrolyte, promoting the impregnation of the battery component and the diffusion of lithium ions within the structure thereof.

As polar polymers that can be used within the scope of the present invention, mention may be made in particular of esters such as polycaprolactone (PCL), ethers such as PEO (polyethylene oxide), carbonates, polyamides, polycaprolactone (PCL) and PVDF (polyvinylidene fluoride).

According to a first embodiment of the method according to the invention, the first and second polymer compositions may be solvented. In this case, the first non-polar polymer composition will further comprise a non-polar solvent and the second polar composition will further comprise a polar solvent. The step b) of mixing the first and second non-polar and polar polymer compositions might then advantageously be carried out for a duration comprised between 1 minute and 30 minutes and at the highest of the temperatures of the two solutions after complete dissolution of said polar and non-polar polymers in the respective solvents thereof. Said non-polar and polar thermoplastic polymers will have been previously dissolved in the respective solvents thereof, advantageously for a period comprised between 30 minutes and 24 hours. In the particular case of this embodiment, the method according to the invention will further comprise, between said steps b) of mixing and c) of extrusion, a step b′) of spreading said composite composition on a planar surface so as to form a composite film, followed by a step b″) of drying, said composite film then being cut into pieces during a cutting step b′″) intended to be inserted into said extruder.

As non-polar solvents that can be used within the scope of the present invention to dissolve the non-polar polymers, mention may be made in particular of, but not limited to, solvents whose resulting dipolar moment is zero, such as hydrocarbons, carbon tetrachloride.

As polar solvents that can be used within the scope of the present invention to dissolve polar polymers, mention may be made in particular of, but not limited to, solvents whose resulting dipolar moment is non-zero, such as dichloromethane, N-methyl-2-pyrrolidone (NMP) and acetone.

According to a second embodiment of the method according to the invention, the first and second non-polar and polar polymer compositions may be free of solvent and introduced separately or as a mixture into the extruder to carry out the mixing step b).

If the liquid organic electrolyte metal-ion battery component that is sought to be made is an electrode, the method according to the invention might be used to make composite filaments, composite films or composite granules from a thermoplastic polymer mixture of at least two immiscible thermoplastic polymers, an electrochemically active material and electronically conductive carbon (introduced during the mixing step b)). It should be noted that the active materials must operate within the electrochemical stability window of the two thermoplastic polymers. Another alternative would be to introduce these fillers into the non-polar polymer solution (first embodiment of the method according to the invention) or directly with the non-polar polymer (solvent-free route) during the extrusion step.

In the case of a positive electrode, a compound selected from the following compounds may be used as an electrochemically active material: compounds with an olivine structure such as LiFePO₄, lamellar compounds of the LiMO₂ or NaMO₂ type with M designating a metal element from Co, Ni, Mn, Al alone or mixture), oxides, sulfides, the NaSICON type structure compounds, and the spinal structure compounds of the LiMn₂O₄ type, whether they are stoichiometric, over-stoichiometric or under-stoichiometric in metal ion.

In the case of a negative electrode, a compound selected from the following compounds taken alone or in a mixture might be used as an electrochemically active material: carbon, Li₄Ti₅O₁₂, metal and intermetallic compounds, alloys, silicon, oxides, sulfides.

As an electronically conductive carbon, carbon nanofibers (usually referred to by the acronym CNF) and/or carbon nanotubes (usually referred to by the acronym CNT) and/or carbon black might advantageously be used within the scope of the present invention.

If the component of the liquid organic electrolyte metal-ion battery that is sought to be made is a separator, the method according to the invention may be used to make composite filaments, composite films or composite granules from a thermoplastic polymer mixture of at least two immiscible thermoplastic polymers free of electrochemically active material and electronically conductive carbon. Advantageously, such a mixture of at least two immiscible thermoplastic polymers may further comprise an electrochemically inactive and insulating material, for example silica to increase the mechanical strength and/or wettability of the separator by the electrolyte.

The method according to the invention allows, up to step c), producing composite films or composite filaments and composite granules. In order to make an organic electrolyte metal-ion battery component from composite films, or from composite filaments or granules obtained in step c), a preferred variant of the method according to the invention may further comprise an additional step d).

If the products obtained at the end of step c) are in the form of composite filaments or composite granules, the additional step d) will be a 3D printing step for producing by FFF or FGF, a liquid organic electrolyte metal-ion battery component of the (positive or negative) electrode or separator type.

If the products obtained at the end of step c) are in the form of composite films, the additional step d) will be an assembly step for producing, from these composite films, a metal-ion battery with liquid organic electrolyte (for example the following configurations: button cell, flexible envelope cell (called “pouch cell”), prismatic, cylindrical cell).

The present invention also relates to a liquid organic electrolyte metal-ion battery component likely to be obtained by the preferred variant of the method according to the invention.

Preferably, the rate of electrochemically active material in the battery component according to the invention might be at least 50% by weight relative to the weight of said component, and may range up to 65% by weight in the case of components in the form of filaments and 75% in the case of components in the form of granules.

The method according to the invention thus allows manufacturing custom-made batteries with a shape that can be adapted, on demand, to the object to be supplied with energy.

Depending on the intended application, integration into the object, allows saving space, maximizing storage capacity or even offerings a more satisfactory aesthetic appearance than a conventional battery.

The present invention also relates to an electrochemical cell comprising at least one battery component according to the invention.

Other advantages and particularities of the present invention will result from the following description, given by way of non-limiting example and made with reference to the appended figures and the examples.

### BRIEF DESCRIPTION OF THE FIGURES

The following examples illustrate the invention, in connection with the figures commented above, without however limiting the scope thereof:

FIG. 1 schematically represents the different steps of the method of solvent-based preparation of a positive electrode filament of a Li-ion battery according to the first embodiment of the method according to the invention;

FIG. 2 schematically represents the different steps of the dry method of producing a positive electrode filament of a Li-ion battery in accordance with the second embodiment of the method according to the invention (solvent-free route, first variant);

FIG. 3 schematically represents the different steps of the dry method of producing a positive electrode filament of a Li-ion battery in accordance with the second embodiment of the method according to the invention (solvent-free pathway, second variant);

FIG. 4 schematically represents the different steps of the dry method of producing a positive electrode filament of a Li-ion battery using a semi-industrial bisvis extruder, in accordance with the second embodiment of the method according to the invention (solvent-free route, second variant);

FIG. 5 comprises backscattered electron scanning electron microscopy images of the surface of the electrode disk of example 1: the left image a) showing the plate face, and the right image b) the nozzle face;

FIG. 6 comprises scanning electron microscopy images (or SEM images) taken on a cross-section of the printed electrode disk of Example 2;

FIG. 7 comprises scanning electron microscopy images (or SEM images) taken on a cross-section of the printed electrode disk of Example 3;

FIG. 8 comprises scanning electron microscopy images (or SEM images) taken on a cross-section of the printed electrode disk of Example 4: this electrode disk shows at the core thereof the PCL/LTO (white grains)/CNF (Long tube)/PBE and PP (dark background);

FIG. 9 shows the specific capacities as a function of the number of cycles of a cell cycled at room temperature containing the printed disk obtained in Example 1 as a working electrode, lithium metal as a counter electrode and a glass fiber separator impregnated with LiPF6 (1M) electrolyte in EC (ethylene carbonate): DEC (diethyl carbonate) (1:1 mass ratio)

FIG. 10 shows the specific capacities as a function of the number of cycles of a cell cycled at 25° C., containing the printed disk obtained in Example 2 as a working electrode, lithium metal as a counter electrode and a glass fiber separator impregnated with the LiPF6 (1M) electrolyte in EC: DMC (dimethyl carbonate) (3:7 mass ratio);

FIG. 11 shows the specific capacities as a function of the number of cycles of a cell cycled at 25° C., containing the printed disk obtained in Example 3 as a working electrode, lithium metal as a counter electrode and a glass fiber separator impregnated with the LiPF6 electrolyte (1M) in EC:DMC (3:7 mass ratio);

FIG. 12 shows the specific capacities as a function of the number of cycles of a cell cycled at 25° C., containing the printed disk obtained in Example 4 as a working electrode, lithium metal as a counter electrode and a glass fiber separator impregnated with the LiPF6 (1M) electrolyte in EC: MEC (methyl ethyl carbonate) (3:7 mass ratio).

FIG. 13 shows the specific capacities as a function of the number of cycles of a cell cycled at 25° C., containing the printed disk obtained in Example 5 as a working electrode, lithium metal as a counter electrode and a glass fiber separator impregnated with the LiPF6 (1M) electrolyte in EC: MEC (methyl ethyl carbonate) (3:7 mass ratio). FIG. 14: FIG. 14 shows the conductivity value of a printed separator of the PP/PCL polymer mixture (50/50 mass ratio) impregnated with LiPF6 electrolyte (1M) in EC/MEC (3/7 mass ratio), compared to the values obtained in a glass fiber separator and a commercial PP separator;

FIG. 15 schematically illustrates the main preparation steps of the composite disks from the filament prepared by the solvent method; the disk contains only a single thermoplastic polar polymer of the PLA type;

FIG. 16 shows the evolution of the specific capacities as a function of the number of cycles of a cell cycled at ambient temperature containing a printed disk based on the positive active material Graphite (+PLA, PEGDME500, graphite, C45) as a working electrode, lithium metal as a counter electrode and a glass fiber separator impregnated with the electrolyte LiPF6 (1M) in EC:DEC (1:1 mass ratio);

FIG. 17 shows transmission electron microscopy images of a section made on a negative electrode filament comprising: on part (a), small CSP carbon black particles dispersed in the PLA (gray background), and on part b), an image has stronger magnification in a region close to a graphite particle (circled in red);

FIG. 18 is an image by scanning electron microscopy of cracks observed in the negative electrode of Example 4 after cycling.

### EXAMPLES

The raw materials of the polymer compositions (polar, non-polar polymers, polar and non-polar solvents), the electrochemically active material and the electronically conductive carbon, as well as the materials used (extruder and 3D printer) are detailed below.

### Raw-Material

### First Polymer Composition

first non-polar polymers: polypropylene (PP)
second nonpolar polymers: polyolefin-based elastomer (PBE)
non-polar solvents: cyclohexane;

### Second Polymer Composition

polar polymers: polyethylene oxide (PEO), polycaprolactone (PCL)
polar solvents: dichloromethane

### Electrochemically Active Material (or Active Material):

LiFePO₄ (usually referred to as LFP, particle size D50: 2-6 μm)
Li₄Ti₅O₁₂ (usually referred to by the acronym LTO).

### Electronically Conductive Carbon:

carbon nanofiber mixture (usually referred to by the acronym CNF: 100 nm wide×20-200 μm long) and carbon nanotubes (usually referred to by the acronym CNT: 9.5 nm wide×1.5 μm long);
carbon nanofibers (CNF: 100 nm wide×20-200 μm long)
Carbon black (C45)

### Materials

laboratory extruder marketed under the trade name HAAKE MiniLab III, by the company Thermo Fischer Scientific,
bivis semi-industrial extruder marketed under the trade name Process 11, by the company ThermoFisher Scientific,
3D printer marketed under the trade name Original Prusa i3 MK3 3D by the company Prusa;
single screw extruder under the trade name Filabot Original, by the company Filabot Triex LLC, USA).

### Example 1

### Solvent-Based Preparation of a Positive Electrode Disk of a Li-Ion Battery in Accordance with the First Embodiment of the Method According to the Invention

In this example, a positive electrode disk of a Li-ion battery is produced by 3D printing according to the first embodiment of the method according to the invention.

An extruder allowing manufacturing the filament is fed by pieces of a composite film prepared by solvent. This film consists of two thermoplastic polymers, the polypropylene (PP) polymer inert with respect to the electrolyte and the poly(ethylene oxide) responsible for transporting the electrolyte within the electrode by impregnation, the active material LiFePO₄ (particle size D50:2-6 μm) and two electronically conductive carbons of the nanofiber type (CNF: 100 nm wide×20-200 μm long) and nanotube (CNT; 9.5 nm wide×1.5 μm long), according to the following mass percentages: PP:33%, PEO:13%, LiFePO₄:49%, CNF:2.5%, CNT:2.5%.

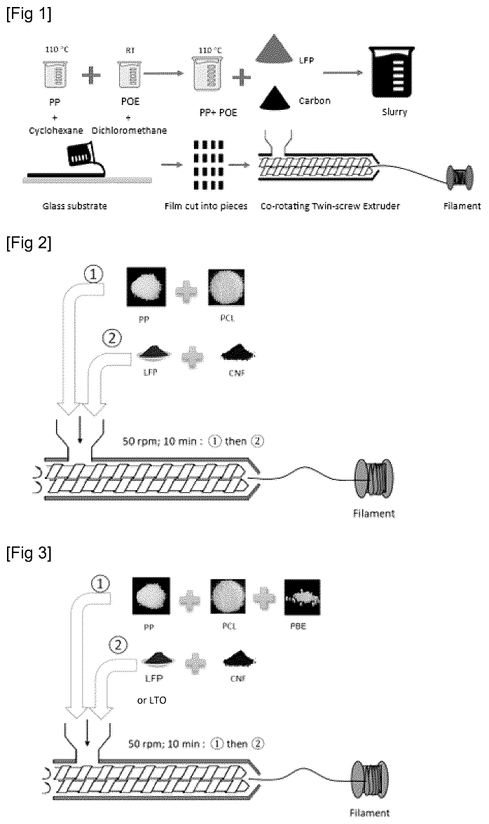

The manufacture of the composite film (as illustrated in FIG. 1) comprises the following steps: the PP and PEO polymers are pre-dissolved separately in cyclohexane at 110° C. and dichloromethane at ambient temperature, respectively. The two solutions are mixed then the fillers (carbon then LiFePO₄) are added. The mixture is spread on a glass plate. After drying, the thin film is cut into pieces, which are then introduced into the extruder.

The filament with a diameter of 2 mm is obtained using the laboratory extruder provided with two co-rotating screws, at a temperature of 190° C. The residence time of the material in the extruder (7 cm³) is about 15 minutes and the screw rotation speed of 50 rpm. The filament thus obtained has an electronic conductivity of about 9 10⁻² S/cm.

It supplies a printer (Original Prusa i3 MK3 3D) whose nozzle and plate temperatures are 260 and 100° C. respectively, for printing the disk with a diameter of 12.7 cm and a thickness of 170 μm.

The analysis of the images (see FIG. 5) of the printed disk surfaces obtained by scanning electron microscopy in backscattered electron mode clearly demonstrates the non-miscible nature of the polymers. The particles of active material LiFePO₄ (LFP) and conductive carbon are located exclusively in the PP polymer.

The printed disk is cycled in an electrochemical cell comprising this working electrode against a lithium metal based counter electrode and a glass fiber separator impregnated with the liquid electrolyte. This is composed of LiPF₆ (1M) lithium salt solubilized in a mixture of EC (ethylene carbonate) and DEC (diethyl carbonate), in a mass ratio of 1:1.

The cell is cycled at ambient temperature, at a constant current between 2.6 and 4V versus Li⁺/Li°. The calculated capacities per gram of active material LFP, obtained at a rate of C/40 (150 mAh/g) and C/20 (130 mAh/g), are close to the theoretical capacity of the LFP of 170 mAh/g, as illustrated in FIG. 9.

### Example 2

### Dry Preparation of a Positive Electrode Disk of a Li-Ion Battery in Accordance with the Second Embodiment of the Method According to the Invention (Solvent-Free Route, First Variant)

This example describes the dry preparation steps of a Li-ion battery positive electrode disk according to the second embodiment of the method according to the invention (as illustrated in FIG. 2).

The filament (diameter 2 mm) is manufactured using the laboratory extruder provided with two co-rotating screws. The extrusion temperature is set at 200° C., the residence time of the material in the extruder (7 cm³) is about 15 minutes and the screw rotation speed is 50 rpm.

The extruder is fed by the following constituents: two thermoplastic polymers in the form of granules, the polypropylene (PP) polymer inert with respect to the electrolyte and the polycaprolactone (PCL) responsible for transporting the electrolyte within the electrode by impregnation, the active material LiFePO₄ (particle size D50: 2-6 μm) and an electronically conductive carbon of the nanofiber type (CNF: 100 nm wide×20-200 μm long), according to the following mass percentages: PP: 23.7%, PCL: 15.8%, LiFePO₄:55%, CNF: 5.5%. The introduction of these components into the extruder at 215° C. was carried out in two stages. The PP and PCL granules are first introduced to ensure homogeneity of the mixture of the fused polymers, then the homogeneous mixture of fillers, LiFePO₄ and carbon is added. These two powders are pre-mixed, for 10 hours, in a container containing zirconium beads subjected to three-dimensional movement.

The resulting filament has an electronic conductivity of about 8.3 S/m.

It supplies a printer (Original Prusa i3 MK3 3D) with a nozzle and plate temperature of 220 and 100° C. respectively, for printing the disk with a diameter of 12.5 cm and a thickness of 200 μm.

The analysis of the images (see FIG. 6) taken at the core of the electrode, by scanning electron microscopy, shows a venous morphology of the PCL, in particular a PCL vein (in red on the left) in a matrix LFP (white grains)/CNF (in green on the left)/PP (dark background).

The printed disk is cycled in an electrochemical cell comprising this working electrode against a lithium metal based counter electrode and a glass fiber separator impregnated with the liquid electrolyte. This is composed of LiPF₆ (1M) lithium salt solubilized in a mixture of EC (ethylene carbonate) and DMC (dimethyl carbonate), with a mass ratio of 3:7.

Thus assembled, the cell undergoes a storage step at 47° C. for 24 h in order to allow the electrolyte to be impregnated within the electrode. Then, it is cycled at 25° C., at a constant current between 2.6 and 4V versus Li⁺/Li°. The capacities calculated per gram of active material LFP, are obtained at a rate of C/40 (156 mAh/g) and C/20 (146 mAh/g), C/10 (138 mAh/g) are close to the theoretical capacity of the LFP of 170 mAh/g, as illustrated in FIG. 10.

### Example 3

### Dry Preparation of a Positive Electrode Disk of a Li-Ion Battery in Accordance with the Second Embodiment of the Method According to the Invention (Solvent-Free Route, Second Variant)

This example describes the dry preparation steps of a Li-ion battery positive electrode disk according to the second embodiment of the method according to the invention (as illustrated in FIG. 3).

In order to produce a coilable filament under industrial conditions, the polymer (polypropylene) inert with respect to the electrolyte is partially replaced by an elastomer (2^{nd} variant of the second embodiment of the method according to the invention).

The filament (diameter 2 mm) is manufactured using the laboratory extruder provided with two co-rotating screws. The extrusion temperature is set at 215° C., the residence time of the material in the extruder (7 cm³) is about 15 minutes and the screw rotation speed is 50 rpm.

The extruder is fed by three thermoplastic polymers in the form of granules: the polypropylene (PP) polymer inert with respect to the electrolyte, a polyolefin-based elastomer (PBE) that provides a greater flexibility to the final filament and is also inert to the electrolyte, and polycaprolactone (PCL) complements this mixture, it is responsible for transporting the electrolyte within the electrode by impregnation. Active material LFP and a carbon of the nanofiber type are incorporated (CNF: 100 nm wide×20-200 μm long), according to the following mass percentages: PP: 17.775%, PBE: 5.925%: PCL: 15.8%, LFP: 55%, CNF: 5.5%.

The introduction of these components into the extruder was carried out in two stages. PP, PBE and PCL granules are introduced first to ensure the homogeneity of the mixture of the fused polymers, then the homogeneous mixture of fillers, LiFePO₄ and carbon, is added. These two powders are pre-mixed, for 10 h, in a container containing zirconium beads subjected to a three-dimensional movement.

The filament thus obtained has an electronic conductivity of about 4.84 S/m.

It supplies a 3D printer with a nozzle and plate temperature of 220 and 50° C. respectively, for printing the 12.5 cm diameter and 200 μm thick disk.

The analysis of the images (see FIG. 7) taken at the core of the electrode, by scanning electron microscopy, shows PCL growths in an LFP/CNF/PP and PBE matrix.

The printed disk is cycled in an electrochemical cell comprising this working electrode against a lithium metal based counter electrode and a glass fiber separator impregnated with the liquid electrolyte. The electrolyte used is a mixture of LiPF₆ (1mol/L), EC (ethylene carbonate) and DMC (dimethyl carbonate) e with a mass ratio of 3:7.

Thus assembled, the cell undergoes a storage step at ambient temperature for 24 h in order to allow the electrolyte to be impregnated within the electrode. Then, it is cycled at 25° C., at a constant current between 2.8 and 4V versus Li⁺/Li°. The capacities are calculated per gram of active material of LifePO₄, they are obtained at a rate of C/40 (165 mAh/g), C/20 (149 mAh/g) and C/10 (143 mAh/g), C/5 (131.5mAh/g), C/2 (102mAh/g) and C/10 (143 mAh/g), as illustrated in FIG. 11.

### Example 4

### Dry Preparation of a Li-Ion Battery Negative Electrode Disk in Accordance with the Second Embodiment of the Method According to the Invention

This example describes the dry preparation steps of a Li-ion battery negative electrode disk according to the second embodiment of the method according to the invention (as illustrated in FIG. 3).

In order to produce a coilable filament, the polymer (polypropylene) inert with respect to the electrolyte is partially replaced by an elastomer (2^{nd} variant of the second embodiment of the method according to the invention).

The filament (diameter 2 mm) is manufactured using the laboratory extruder provided with two co-rotating screws. The extrusion temperature is set at 215° C., the residence time of the material in the extruder (7 cm³) is about 15 minutes and the screw rotation speed is 50 rpm.

The extruder is fed by three thermoplastic polymers in the form of granules: the polypropylene (PP) polymer inert with respect to the electrolyte, a polyolefin-based elastomer (PBE) that provides a greater flexibility to the final filament and is also inert with respect to the electrolyte; polycaprolactone (PCL) complements this mixture to transport the electrolyte within the electrode by impregnation. LTO active material and a carbon of the nanofiber type are incorporated (CNF: 100 nm wide×20-200 μm long), according to the following mass percentages: PP: 15.642%, PBE: 7.821%: PCL: 15.8%, LTO: 55%, CNF: 5.5%.

The introduction of these components into the extruder was carried out in two stages. PP, PBE and PCL granules are introduced first to ensure homogeneity of the fused polymer mixture, then the homogeneous mixture of fillers, LTO and carbon, is added. These two powders are pre-mixed, for 10 h, in a container containing zirconium beads subjected to a three-dimensional movement.

The filament thus obtained has an electronic conductivity of about 3.91 S/m.

It supplies a printer (Original Prusa i3 MK3 3D) with a nozzle and plate temperature of 220 and 50° C. respectively, for printing the 12.5 cm diameter and 200 μm thick disk.

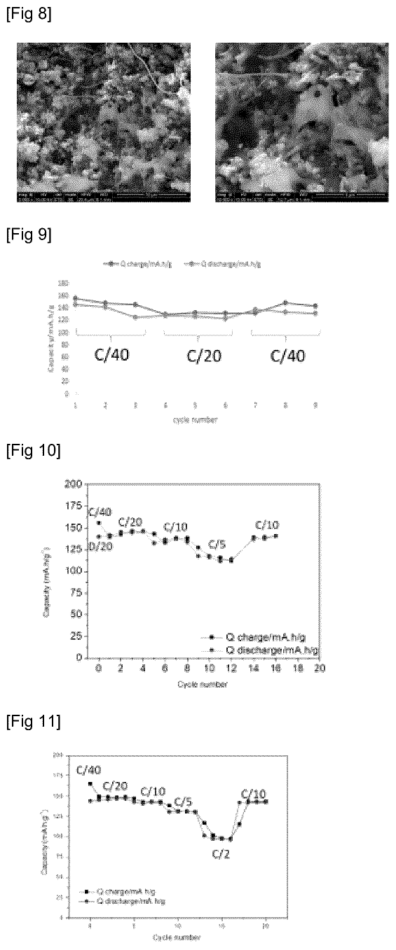

The analysis of the images (see FIG. 8) taken at the core of the electrode, by scanning electron microscopy, shows a venous morphology of the PCL.

The printed disk is cycled in an electrochemical cell comprising this working electrode against a lithium metal based counter electrode and a glass fiber separator impregnated with the liquid electrolyte. This electrolyte is composed of LiPF₆ (1M) lithium salt solubilized in a mixture of EC (ethylene carbonate) and MEC (methyl ethyl carbonate), mass ratio 3:7.

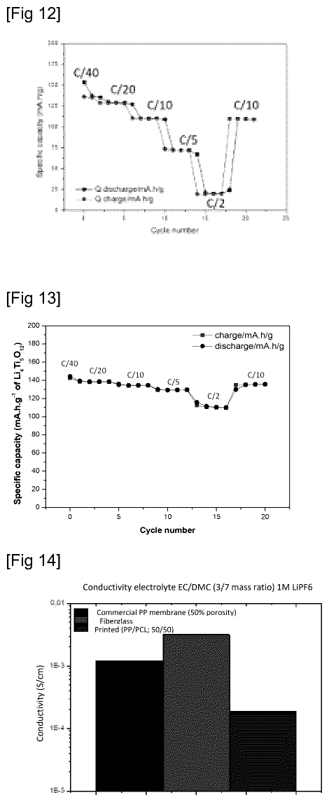

Thus assembled, the cell undergoes a storage step at ambient temperature for 24 h in order to allow the electrolyte to be impregnated within the electrode. Then, it is cycled at 25° C., at a constant current between 1 and 2V versus Li⁺/Li°. The capacities calculated per gram of LTO active material are obtained at a rate of C/40 (136 mAh/g), C/20 (129 mAh/g), C/10 (110 mAh/g), C/5 (70 mAh/g), C/2 (20 mAh/g), and C/10 (110 mAh/g), as illustrated in FIG. 12.

### Example 5

### Dry Preparation of a Li-Ion Battery Negative Electrode Disk in Accordance with the Second Embodiment of the Method According to the Invention

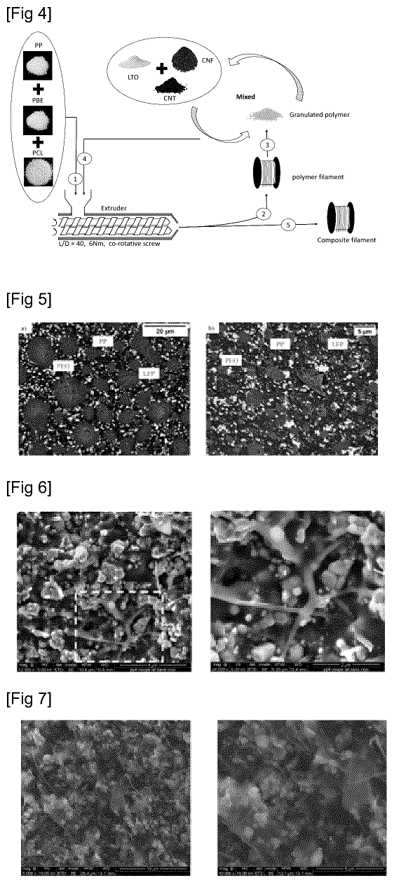

This example describes the dry preparation steps of a Li-ion battery negative electrode disk according to the second embodiment of the method according to the invention (as illustrated in FIG. 4).

In order to produce a coilable filament under industrial conditions, the polymer (polypropylene) inert with respect to the electrolyte is partially replaced by an elastomer in greater amount than in Example 4 (2^{nd} variant of the second embodiment of the method according to the invention).

The filament (diameter 2 mm) of final composition PP/PBE/PCL/LTO/CNF/CNT (according to the mass percentages 11.85/11.85/15.8/55/2.75/2.75) is manufactured using a semi-industrial extruder provided with two co-rotating screws. The extrusion temperature is set at 215° C. The torque on the screws is set at 6 Nm.

The extruder is firstly fed by the three thermoplastic polymers in the form of granules: the polypropylene polymer (PP) inert with respect to the electrolyte, a polyolefin-based elastomer (PBE) that provides a greater flexibility to the final filament and is also inert with respect to the electrolyte; polycaprolactone (PCL) complements this mixture to transport the electrolyte within the electrode by impregnation. The polymer filament then produced is cut into granules.

These granules are mixed with the active material LTO and two carbons, one of the nanofiber type (CNF: 100 nm wide×20-200 μm long), the other of the nanotube type (CNT: 9.5 nm wide×1.5 μm long), 50 g of materials are mixed for 10 hours in a container containing zirconium beads subjected to a three-dimensional movement.

The mixture is fed back into the extruder.

The filament thus obtained feeds a printer (Original Prusa i3 MK3 3D) whose nozzle and plate temperature is 220 and 50° C. respectively, for printing the disk with a diameter of 12.5 cm and a thickness of 200 μm.

The printed disk is cycled in an electrochemical cell comprising this working electrode against a lithium metal based counter electrode and a glass fiber separator impregnated with the liquid electrolyte. This electrolyte is composed of LiPF₆ (1M) lithium salt solubilized in a mixture of EC (ethylene carbonate) and MEC (methyl ethyl carbonate), mass ratio 3:7.

Thus assembled, the cell undergoes a storage step at ambient temperature for 24 h in order to allow the electrolyte to be impregnated within the electrode. Then, it is cycled at 25° C., at a constant current between 1 and 2V versus Li⁺/Li°. The capacities calculated per gram of active material of LTO, are obtained at a rate of C/40 (140.3 mAh/g), C/20 (138 mAh/g), C/10 (134.3 mAh/g), C/5 (129.2 mAh/g), C/2 (110.1 mAh/g), and C/10 (135.2 mAh/g), as illustrated in FIG. 13. It is thus noted that the industrial method leads to a strong improvement in the performance of the printed electrode at a fast cycling rate (comparison FIG. 12 and FIG. 13 C/5 and C/2).

### Example 6

### Dry Preparation of a Li-Ion Battery Separator in Accordance with the 1^{st}/2^{nd} Embodiment of the Method According to the Invention

In this example, a Li-ion battery separator disk is produced by FFF (3D printing).

The filament (diameter 2 mm) is manufactured using a laboratory extruder (HAAKE MiniLab III, Thermo Scientific) provided with two co-rotating screws. The extrusion temperature is set at 215° C., the residence time of the material in the extruder (7 cm³) is about 15 minutes and the screw rotation speed is 50 rpm.

The extruder is fed by two thermoplastic polymers in the form of granules, the non-polar polymer PP (polypropylene) and the polar polymer PCL (polycaprolactone) according to the following mass percentages: PP:60%, PCL:40%.

The obtained filament feeds a 3D printer (Original Prusa i3 MK3 3D) whose nozzle and plate temperature is 220 and 50° C. respectively, for printing the disk with a diameter of 12.5 cm and a thickness of 200 μm.

This printed separator is impregnated with the liquid electrolyte composed of LiPF₆ (1M) lithium salt solubilized in a mixture of EC and MEC, at a mass ratio of 3:7 and then introduced into an electrochemical cell to measure ion conductivity at 25° C.

The obtained ion conductivity is 1.87 10⁻⁴ S/cm, a value close to the conductivities obtained in a commercial polypropylene separator (thickness 25 μm, porosity 50%) and in a glass fiber separator, of 1.2 10⁻³ and 3.1 10⁻³ S/cm respectively.

### Comparative Example CE1:1 Single Polymer (PLA)

In this example, a Li-ion battery negative electrode disk is produced by 3D printing according to the fused filament fabrication (FFF) method. The extruder used to manufacture the filament is fed by pieces of a composite film prepared by solvent. This example illustrates the problems encountered when introducing a single polar thermoplastic polymer into the component.

The film consists of a thermoplastic polymer, PLA (polylactic acid), the active material graphite (TIMREX SLS graphite: 1.5 m² g⁻¹, d₅₀=14 μm, d₉₀=26 μm, supplied by Timcal), an electronic conductor of the Carbon Super P type (62 m²/g), and the plasticizer PEGDME500 (Poly(ethylene glycol) dimethyl ether molar mass ˜500) according to the following mass percentages: PLA:33%, PEGDME500:13%, graphite: 49%, C45:5%. Plasticizer is added to give the filament a minimum of flexibility in order to make it printable, without plasticizer this film is very brittle.

The manufacturing of the composite film comprises the following steps: the PLA polymer is dissolved for 2 hours in dichloromethane at room temperature, then the plasticizer and the fillers (C45 carbons and graphite) are added. These two powders C45 and graphite are pre-mixed, for 10 h, in a container containing zirconium beads subjected to a three-dimensional movement.

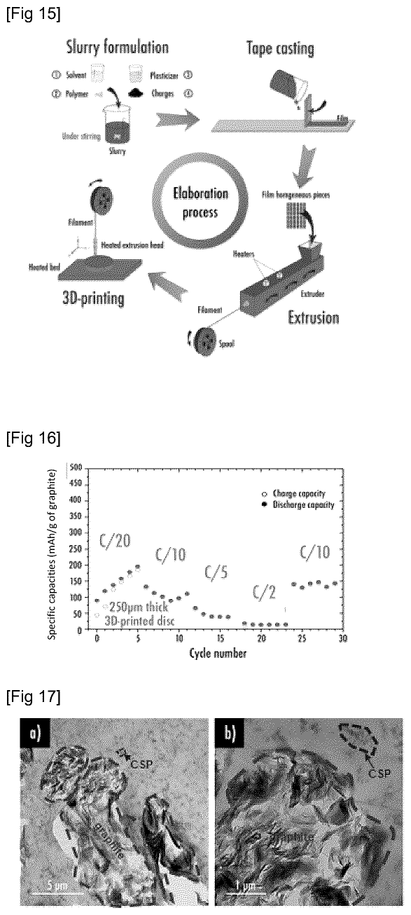

The mixture is spread on a glass plate. After drying, the thin film is cut into pieces, which are then fed into the extruder (as illustrated in FIG. 15).

The 2 mm diameter filament is manufactured using a single-screw extruder (Filabot Original), at a temperature of 190° C.

The printed disk is cycled in an electrochemical cell comprising this working electrode against a lithium metal based counter electrode and a glass fiber separator impregnated with the liquid electrolyte. This electrolyte is composed of LiPF₆ (1M) lithium salt solubilized in a mixture of EC (ethylene carbonate) and DEC (diethyl carbonate), in a mass ratio of 1:1.

Thus assembled, the cell undergoes a storage step at ambient temperature for 24 hours in order to allow the electrolyte to be impregnated within the electrode. The cell is cycled at ambient temperature, at a constant current between 2.6 and 4V versus Li⁺/Li°.

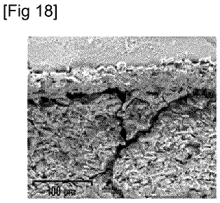

On the one hand, it is observed that the capacity increases regularly during the first 6 cycles (FIG. 16), reflecting difficult and gradual impregnation of the electrode disk. On the other hand, the capacities calculated per gram of active material (graphite), obtained at different rates are much lower than the theoretical capacity of graphite of 372 mAh/g. This is explained by discontinuous electronic percolation pathways linked to the low carbon/polymer volume ratio (FIG. 17).

After cycling, the electrode disk tends to shred due to gelling of the PLA polymer with the electrolyte (FIG. 18). This disk has two major drawbacks: slow impregnation of the electrolyte, loss of its mechanical integrity in cycling and low electronic percolation leading to low electrochemical performance.

What is claimed is:

1. A method for manufacturing composite filaments, composite films or composite granules for a liquid organic electrolyte metal-ion battery component, said method comprising the steps of:
a. providing or preparing at least two thermoplastic polymer compositions, including
a first non-polar polymer composition comprising a first non-polar thermoplastic polymer, said first non-polar thermoplastic polymer having a melting temperature Tf1 and having no affinity with the liquid organic electrolyte of said metal-ion battery to which it is intended to be integrated, and
a second polar polymer composition comprising a polar thermoplastic polymer, said polar polymer having a melting temperature Tf2 and having an affinity with said liquid organic electrolyte, said non-polar thermoplastic polymer and said first polar thermoplastic polymer being immiscible,
b. mixing said at least first and second non-polar and polar polymer compositions, to form a thermoplastic polymer mixture;
c. introducing said composite composition into an extruder, then forming by extrusion composite granules, or composite filaments or films;
said extrusion step being performed at a temperature Te which is equal to or greater than the temperature of said thermoplastic polymer mixture;
said composite granules, or said composite films or said composite filaments thus obtained at the end of the extrusion step consisting of a polymer matrix having a co-continuous morphology of said polar thermoplastic polymer and said first non-polar thermoplastic polymer.

2. The method according to claim 1, wherein said non-polar polymer is selected from olefins, and mixtures thereof, and preferably is polypropylene (PP) or polyethylene (PE).

3. The method according to claim 1, wherein said first polymer composition comprises at least one second non-polar thermoplastic polymer selected from saturated or unsaturated elastomeric non-polar polymers and/or mixtures thereof, and preferably a polyolefin-based elastomer (PBE).

4. The method according to claim 1, wherein said polar thermoplastic polymer is selected from esters, ethers, carbonates, polyamides, and PVDF.

5. The method according to claim 1, wherein:
said first non-polar polymer composition further comprises a non-polar solvent and said second polar polymer composition further comprises a polar solvent;
the step b) of mixing the first and second non-polar and polar polymer compositions is performed for a duration comprised between 1 minute and 30 minutes and at the highest of the temperatures of the two solutions after complete dissolution of said non-polar and polar polymers in the respective solvents thereof;
said method further comprises, between said b) mixing and c) extrusion steps, a step b') of spreading said composite composition on a planar surface so as to form a composite film, followed by a drying step b″), said composite film then being cut into pieces during a cutting step b″′) which are intended to be inserted into said extruder.

6. The method according to claim 5, wherein the non-polar solvent is a solvent whose resulting dipolar moment is zero, and preferably selected from hydrocarbons, carbon tetrachloride.

7. The method according to claim 5, wherein the polar solvent is a solvent whose resulting dipolar moment is non-zero, and preferably selected from dichloromethane, N-methyl-2-pyrrolidone (NMP) and acetone.

8. The method according to claim 1, wherein said first non-polar polymer compositions and second polar polymer compositions are solvent-free and are introduced separately or as a mixture into the extruder to carry out the mixing step b).

9. The method according to claim 1, wherein during step b) of mixing into the thermoplastic polymer mixture, an electrochemically active material and electronically conductive carbon are introduced.

10. The method according to claim 9, wherein said liquid organic electrolyte metal-ion battery component is a positive electrode and said electrochemically active material is selected from olivine structure compounds such as LiFePO4, lamellar compounds of the LiMO2 or NaMO2 type with M designating a metal element from Co, Ni, Mn, Al alone or mixture), oxides, sulfides, NaSICON type structure compounds, and spinel structure compounds of the LiMn2O4 type, whether stoichiometric, over-stoichiometric or sub-stoichiometric in metal ion.

11. The method according to claim 9, wherein said liquid organic electrolyte metal-ion battery component is a negative electrode and said electrochemically active material is selected from the following compounds taken alone or in mixture: carbon, Li4Ti5O12, metal and intermetallic compounds, alloys, silicon, oxides and sulfides.

12. The method according to claim 9, wherein the electronically conductive carbon comprises carbon nanofibers (CNF) and/or carbon nanotubes (CNT) and/or carbon black.

13. The method according to claim 1, wherein said liquid organic electrolyte metal-ion battery component is a separator and said thermoplastic polymer mixture is free of electrochemically active material and electronically conductive carbon and optionally contains charges.

14. The method according to claim 13, wherein an electrochemically inactive and insulating material, and preferably silica, is introduced during the mixing step b).

15. The method according to claim 1, further comprising a 3D printing step for making, from composite filaments or composite granules, a liquid organic electrolyte metal-ion battery component.

16. The method according to claim 1, further comprising a step of assembling composite films, to manufacture a liquid organic electrolyte metal-ion battery component.

17. A liquid organic electrolyte metal-ion battery component to be obtained by a method as defined according to claim 15.

18. The component of claim 17, wherein the rate of electrochemically active material is at least 40% by weight relative to the weight of said component.

19. An electrochemical cell comprising at least one component as defined according to claim 17.
